(19) United States
(12) Patent Application Publication
(10) Pub. No.: US 2018/0173549 A1
(43) Pub. Date: Jun. 21, 2018

(54) VIRTUAL NETWORK FUNCTION PERFORMANCE MONITORING

(71) Applicant: Intel Corporation, Santa Clara, CA (US)

(72) Inventors: John J. Browne, Limerick (IE); Tomasz Kantecki, Ennis (IE); Timothy Verrall, Pleasant Hill, CA (US); Maryam Tahhan, Limerick (IE); Eoin Walsh, Shannon (IE); Rory Browne, Shannon (IE); Tarun Viswanathan, Folsom, CA (US)

(73) Assignee: Intel Corporation, Santa Clara, CA (US)

(21) Appl. No.: 15/382,075

(22) Filed: Dec. 16, 2016

(51) Int. Cl. G06F 9/455; G06F 9/50

(52) U.S. Cl. CPC G06F 9/45558; G06F 9/5077; G06F 2009/45583; G06F 2009/45595; G06F 2009/45591

(57) ABSTRACT

There is disclosed in an example, a computing apparatus, including: a processor having a resource direction capability; and one or more logic elements providing a network function virtualization orchestrator (NFVO) engine to: store for a virtual machine (VM) an extended performance profile, comprising a metric from the resource direction capability.

This disclosure relates in general to the field of network virtualization, and more particularly, though not exclusively to, a system and method for virtual network function performance monitoring.

### BACKGROUND

Network function virtualization (NFV) is a method of providing certain network functions as virtual appliances. These functions may be referred to as virtual network functions (VNFs). In the past, the functions provided by these VNFs may have been provided by bespoke hardware service appliances.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a block diagram of a security-enabled network according to one or more examples of the present specification.

FIG. 2 is a block diagram of a computing device according to one or more examples of the present specification.

FIG. 3 is a block diagram of a server according to one or more examples of the present specification.

FIG. 4 is a block diagram of a network function virtualization (NFV) architecture according to one or more examples of the present specification.

FIG. 5 is a block diagram of a service chain according to one or more examples of the present specification.

FIG. 6 is a block diagram of various cache levels according to one or more examples of the present specification.

FIG. 7 is a block diagram of performance logging according to one or more examples of the present specification.

FIG. 8 is a flow chart of a method of performance logging according to one or more examples of the present specification

FIGS. 9a and 9b are a flow chart of a method of applying performance logging information according to one or more examples of the present specification.

FIG. 10 is a block diagram of metrics according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

The specification provides solutions to the problem of a management or orchestration system automatically detecting and recovering from capacity failures in deployed VNFs. Capacity failures include VNF overload, VNF underload, and VNF stall conditions, by way of nonlimiting example. These in turn may lead to service level agreement (SLA) violations. As used throughout this specification, a VNF “failure” includes a VNF overload, VNF underload, or a VNF stall.

Existing solutions include checking the host statistics and VNF statistics to determine if the host's resources are oversubscribed. But existing metrics may not be sufficient, in every case, to determine VNF overload, VNF underload and VNF stalls. This specification provides particular processes used after a VNF has been placed, including VNF capacity monitoring, VNF capacity failure detection, and VNF recovery procedures for capacity failures. Specifically, the methods disclosed herein detect and recover from VNF failures using a VNF Profile and Extended Platform Metrics.

The method improves VNF failure detection by extending host platform metrics to include current information on cache and memory bandwidth, and also uses a VNF Performance Profile, which contains an extended resource utilization mapped to actual performance points. These metrics may advantageously utilize a hardware resource extension on the CPU, such as Intel® Resource Director Technology (RDT), which is available on some modern Intel® processors, such as the Xeon® line.

For example, existing Platform Metrics for VNFs include the following, by way of nonlimiting example:
a. Memory footprint (RAM).
b. Disk usage.
c. Network ports used.
d. CPU clock speed.
e. Number of CPUs.

The VNF Performance Profile includes the following, by way of nonlimiting example a set of performance points with matching resource utilization.

A VNF uses a number of system resources. For example:
a. [Network Port metrics] can be supplied by DPDK, vSwitch or network driver.
b. [RAM metrics] Per application memory bandwidth data is supplied by Intel® RDT (Intel® Resource Director Technology) (MBM) (Memory Bandwidth Monitoring).
c. [Cache metrics] Per application cache occupancy is supplied by Intel® RDT (CMT) (Cache Monitoring Technology) and misses/hits are architectural performance counters.
d. [CPU metrics] are standard/architectural performance counters. Number of CPU's can be taken from the OS or VMM (Virtual Machine Manager).

Using this information, VNF performance may be measured as a packet throughput and/or IPC (Instructions per Cycle).

A VNF profile may then be constructed, comprising, by way of nonlimiting example:
a. VNF performance vs. consumed resources (e.g., RAM, cache, CPU)
b. Each VNF can be benchmarked in isolation to identify its performance points. This creates a performance plot.

An extended performance profile may also be defined to include the following, by way of nonlimiting example:
a. Available last level cache (LLC) size
b. Memory bandwidth (available vs. maximum supported by the system)

Now VNF profile performance points for two example VNFs (VNF_A and VNF_B) may be built as follows (using illustrative data points for cache utilization and memory bandwidth):

| | VN F_A | | | VN F_B | | |
|---|---|---|---|---|---|---|
| | Million | LLC | Memory | Million | LLC | Memory |
| SLA | Pack- | occupancy | bandwidth | Pack- | occupancy | bandwidth |
| Type | ets/s | [MB] | [GB/s] | ets/s | [MB] | [GB/s] |
| A | 28 | 20 | 0.5 | 40 | 20 | 5.0 |
| B | 24 | 15 | 0.8 | 32 | 15 | 7.0 |
| C | 14 | 10 | 1.2 | 23 | 10 | 9.5 |
| D | 6 | 5 | 2.0 | 8 | 5 | 15.0 |

It is seen here that the VNF's performance drops as its cache footprint gets reduced. At the same time memory bandwidth increases.

Performance plots can be prepared in isolation with use of Cache Allocation Technology and other techniques to create certain memory bandwidth conditions in the system. Alternatively, it can be built over time based on monitored historical data.

In embodiments of this specification, the following factors may be considered for detecting overload, underload, and stall conditions.

Overload Capacity Check.

This checks for conditions in which currently utilized resources on the VNF performance plot indicate lower than current performance. This means that the current VNF performance is not sustainable, and SLA may be at risk. Corrective action may include adding extra resources, load balancing, migrating, or otherwise providing for more capacity. Taking the above performance plot as an example, an overload condition may be a situation in which application is performing at 29 million packets/s, and its cache utilization is 16 MB.

Underload Capacity Check.

Underload is a condition in which the currently utilized resources, on the VNF performance plot, indicate higher than current performance. In this case, the VNF utilizes more resources than it needs. Corrective actions may include directing extra load to the VNF to optimize resource allocation, or additional VNFs may be placed on the host system. Taking the above performance plot as an example, an underload condition may be a situation in which the application is performing at 15,000,000 packets/s and its cache utilization is 20 MB.

Stall/Deadlock Check.

A “deadlock” may be, for example, where there is zero cache utilization, zero memory bandwidth utilization, and unhalted cycles are at ˜100% of the CPU capacity.

These and other failure modes may be used to determine whether SLAs are achievable under current network conditions. SLA achievability inputs may thus be defined. LLC occupancy and memory bandwidth are not the only metrics that need to be taken in to account when scheduling a new VNF. Yet they are important to SLA, and they complement already used metrics. Key performance indicators (KPIs) that may be considered when scheduling a VNF with an SLA include the following, by way of nonlimiting example:
a. Memory footprint (RAM)
b. Disk requirements
c. Network ports
d. CPU clock speed
e. Number of CPUs
f. LLC (Last Level Cache) size (and available LLC size)
g. Memory bandwidth (available vs. maximum supported by the system)

For example, consider a host system with the following resources:
a. Memory bandwidth 20 GB/s
b. LLC size 45 MB
c. N×10 G network ports
d. M GB RAM
e. X TB of disk space

If the system is scheduled for 2×VNF_B (@ 40 Mpkts/s) then resource usage is as follows:
a. LLC: 2×20 MB=40 MB
b. Memory bandwidth: 2×5.0 GB/s=10 GB/s

This tells the scheduler that remaining resource level in the system allows only for deploying VNF_A or VNF_B at reduced performance level (SLA type D at most). It does not accommodate VNFs at SLA type A to C.

A system and method for virtual network function performance monitoring will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

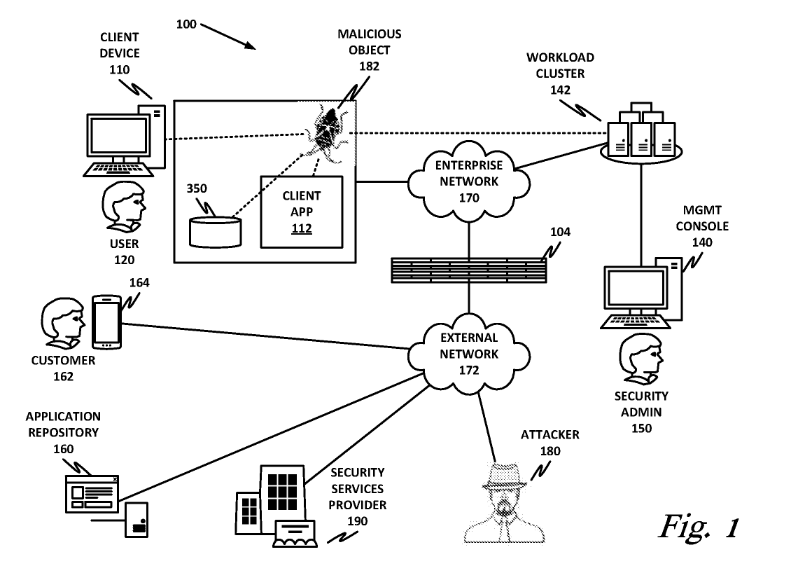

FIG. 1 is a network-level diagram of a secured enterprise 100 according to one or more examples of the present specification. In the example of FIG. 1, enterprise 100 may be configured to provide services or data to one or more customers 162, who may operate user equipment 164 to access information or services via external network 172. This may require enterprise 100 to at least partly expose certain services and networks to the outside world, thus creating a logical security aperture. Thus certain embodiments of the system and method of the present specification are at least partly concerned with securing enterprise 100.

Within enterprise 100, one or more users 120 operate one or more client devices 110. Client devices 110 may be communicatively coupled to one another and to other network resources via enterprise network 170. Enterprise network 170 may be any suitable network or combination of one or more networks operating on one or more suitable networking protocols, including for example, a local area network, an intranet, a virtual network, a wide area network, a wireless network, a cellular network, or the Internet (optionally accessed via a proxy, virtual machine, or other similar security mechanism) by way of nonlimiting example. Enterprise network 170 may also include one or more servers, firewalls, routers, switches, security appliances, antivirus servers, or other useful network devices, which in an example may be virtualized within workload cluster 142. In this illustration, enterprise network 170 is shown as a single network for simplicity, but in some embodiments, enterprise network 170 may include a large number of networks, such as one or more enterprise intranets connected to the internet. Enterprise network 170 may also provide access to an external network, such as the Internet, via external network 172. External network 172 may similarly be any suitable type of network.

A workload cluster 142 may be provided, for example as a virtual cluster running in a hypervisor on a plurality of rack-mounted blade servers, or as a cluster of physical servers. Workload cluster 142 may provide one or more server functions, or one or more “microclouds” in one or more hypervisors. For example, a virtualization environment such as vCenter may provide the ability to define a plurality of “tenants,” with each tenant being functionally separate from the other tenants, and each tenant operating as a single-purpose microcloud. Each microcloud may serve a distinctive function, and may include a plurality of virtual machines (VMs) of many different flavors, including agentful and agentless VMs.

It should also be noted that some functionality of endpoint devices 110 may also be provided via workload cluster 142. For example, one microcloud may provide a remote desktop hypervisor such as a Citrix workspace, which allows users 120 operating endpoints 110 to remotely login to a remote enterprise desktop and access enterprise applications, workspaces, and data. In that case, endpoint 110 could be a “thin client” such as a Google Chromebook, running only a stripped-down operating system, and still provide user 120 useful access to enterprise resources.

One or more computing devices configured as a management console 140 may also operate on enterprise network 170. Management console 140 may provide a user interface for a security administrator 150 to define enterprise security policies, which management console 140 may enforce on enterprise network 170 and across client devices 110 and workload cluster 142. In an example, management console 140 may run a server-class operating system, such as Linux, Unix, or Windows Server. In another case, management console 140 may be provided as a web interface, on a desktop-class machine, or via a VM provisioned within workload cluster 142.

Enterprise 100 may encounter a variety of “security objects” on the network. A security object may be any object that operates on or interacts with enterprise network 170 and that has actual or potential security implications. In one example, security objects may be broadly divided into hardware objects, including any physical device that communicates with or operates via the network, and software objects. Software objects may be further subdivided as “executable objects” and “static objects.” Executable objects include any object that can actively execute code or operate autonomously, such as applications, drivers, programs, executables, libraries, processes, runtimes, scripts, macros, binaries, interpreters, interpreted language files, configuration files with inline code, embedded code, and firmware instructions by way of non-limiting example. A static object may be broadly designated as any object that is not an executable object or that cannot execute, such as documents, pictures, music files, text files, configuration files without inline code, videos, and drawings by way of non-limiting example. In some cases, hybrid software objects may also be provided, such as for example a word processing document with built-in macros or an animation with inline code. For security purposes, these may be considered as a separate class of software object, or may simply be treated as executable objects.

Enterprise 100 may communicate across enterprise boundary 104 with external network 172. Enterprise boundary 104 may represent a physical, logical, or other boundary. External network 172 may include, for example, websites, servers, network protocols, and other network-based services. In one example, an application repository 160 is available via external network 172, and an attacker 180 (or other similar malicious or negligent actor) also connects to external network 172. A security services provider 190 may provide services to enterprise 100.

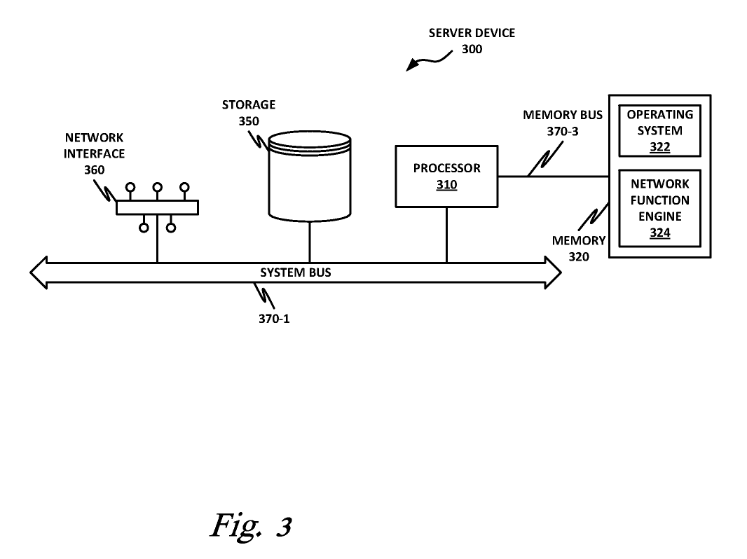

It may be a goal of users 120 and secure enterprise 100 to successfully operate client devices 110 and workload cluster 142 without interference from attacker 180 or from unwanted security objects. In one example, attacker 180 is a malware author, whose goal or purpose is to cause malicious harm or mischief, for example by injecting malicious object 182 into client device 110. Once malicious object 182 gains access to client device 110, it may try to perform work such as social engineering of user 120, a hardware-based attack on client device 110, modifying storage 350 (FIG. 3), modifying client application 112 (which may be running in memory), or gaining access to enterprise servers 142.

The malicious harm or mischief may take the form of installing root kits or other malware on client devices 110 to tamper with the system, installing spyware or adware to collect personal and commercial data, defacing websites, operating a botnet such as a spam server, or simply to annoy and harass users 120. Thus, one aim of attacker 180 may be to install his malware on one or more client devices 110. As used throughout this specification, malicious software (“malware”) includes any security object configured to provide unwanted results or do unwanted work. In many cases, malware objects will be executable objects, including by way of non-limiting examples, viruses, Trojans, zombies, rootkits, backdoors, worms, spyware, adware, ransomware, dialers, payloads, malicious browser helper objects, tracking cookies, loggers, or similar objects designed to take a potentially-unwanted action, including by way of non-limiting example data destruction, covert data collection, browser hijacking, network proxy or redirection, covert tracking, data logging, keylogging, excessive or deliberate barriers to removal, contact harvesting, and unauthorized self-propagation.

Attacker 180 may also want to commit industrial or other espionage against enterprise 100, such as stealing classified or proprietary data, stealing identities, or gaining unauthorized access to enterprise resources. Thus, attacker 180's strategy may also include trying to gain physical access to one or more client devices 110 and operating them without authorization, so that an effective security policy may also include provisions for preventing such access.

In another example, a software developer may not explicitly have malicious intent, but may develop software that poses a security risk. For example, a well-known and often-exploited security flaw is the so-called buffer overrun, in which a malicious user is able to enter an overlong string into an input form and thus gain the ability to execute arbitrary instructions or operate with elevated privileges on a computing device. Buffer overruns may be the result, for example, of poor input validation or use of insecure libraries, and in many cases arise in nonobvious contexts. Thus, although not malicious, a developer contributing software to application repository 160 may inadvertently provide attack vectors for attacker 180. Poorly-written applications may also cause inherent problems, such as crashes, data loss, or other undesirable behavior. Because such software may be desirable itself, it may be beneficial for developers to occasionally provide updates or patches that repair vulnerabilities as they become known. However, from a security perspective, these updates and patches are essentially new objects that must themselves be validated.

Application repository 160 may represent a Windows or Apple “App Store” or update service, a Unix-like repository or ports collection, or other network service providing users 120 the ability to interactively or automatically download and install applications on client devices 110. If application repository 160 has security measures in place that make it difficult for attacker 180 to distribute overtly malicious software, attacker 180 may instead stealthily insert vulnerabilities into apparently-beneficial applications.

In some cases, enterprise 100 may provide policy directives that restrict the types of applications that can be installed from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions and enforcing it on client devices 110.

Enterprise 100 may also contract with or subscribe to a security services provider 190, which may provide security services, updates, antivirus definitions, patches, products, and services. McAfee®, Inc. is a non-limiting example of such a security services provider that offers comprehensive security and antivirus solutions. In some cases, security services provider 190 may include a threat intelligence capability such as the global threat intelligence (GTI™) database provided by McAfee Inc. Security services provider 190 may update its threat intelligence database by analyzing new candidate malicious objects as they appear on client networks and characterizing them as malicious or benign.

In another example, enterprise 100 may simply be a family, with parents assuming the role of security administrator 150. The parents may wish to protect their children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

When a new object is first encountered on the network, security policies may initially treat it as “gray” or “suspect.” As a first line of defense, a security appliance in cluster 142 may query security services provider 190 to see if the new object has a globally-recognized reputation. If so, a local reputation may be generated based on that global reputation. If not, the object is completely new and may be treated as a “candidate malicious object,” meaning that its status is unknown, and it may therefore be a malicious object. At a minimum, the new object may be proscribed in its access to protected resources until its reputation can be established. This may mean that extra permission from a user 120 or security administrator 150 is required for the candidate malicious object to access protected resources.

The candidate malicious object may also be subjected to additional rigorous security analysis, particularly if it is a new object with no global reputation, or if it is an executable object. This may include, for example, submitting the object to an internal security audit, or to security services provider 190, for deep analysis. This may include running the object in a sandbox environment, expert status analysis, or other security techniques. These may help to establish a new reputation for the object.

If the object is permitted to operate on the network and malicious behavior is observed, the object may be tagged as malicious object 182. Remedial action may then be taken as appropriate or necessary. Thus, it is a goal of users 120 and security administrator 150 to configure and operate client devices 110, workload cluster 142, and enterprise network 170 so as to exclude all malicious objects, and to promptly and accurately classify candidate malicious objects.

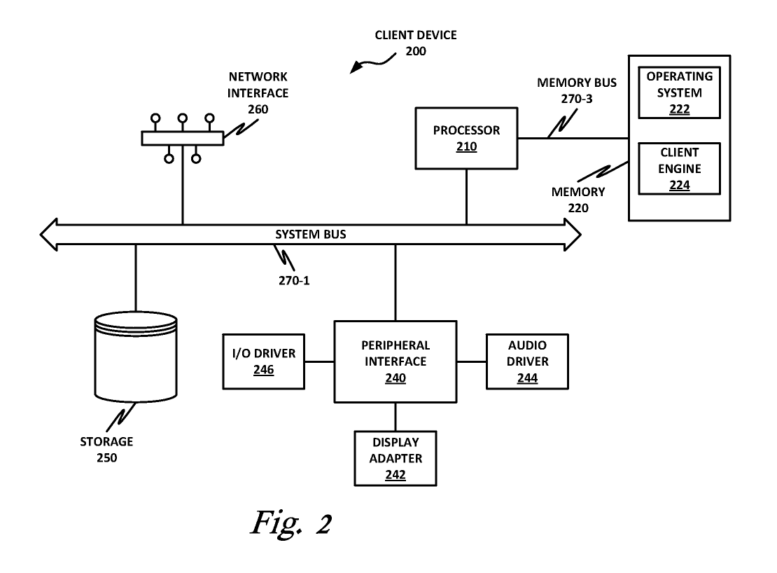

FIG. 2 is a block diagram of client device 200 according to one or more examples of the present specification. Client device 200 may be any suitable computing device. In various embodiments, a “computing device” may be or comprise, by way of non-limiting example, a computer, workstation, server, mainframe, virtual machine (whether emulated or on a “bare-metal” hypervisor), embedded computer, embedded controller, embedded sensor, personal digital assistant, laptop computer, cellular telephone, IP telephone, smart phone, tablet computer, convertible tablet computer, computing appliance, network appliance, receiver, wearable computer, handheld calculator, or any other electronic, microelectronic, or microelectromechanical device for processing and communicating data. Any computing device may be designated as a host on the network. Each computing device may refer to itself as a “local host,” while any computing device external to it may be designated as a “remote host.”

In certain embodiments, client devices 110 may all be examples of client devices 200.

Client device 200 includes a processor 210 connected to a memory 220, having stored therein executable instructions for providing an operating system 222 and at least software portions of a client engine 224. Other components of client device 200 include a storage 250, network interface 260, and peripheral interface 240. This architecture is provided by way of example only, and is intended to be non-exclusive and non-limiting. Furthermore, the various parts disclosed are intended to be logical divisions only, and need not necessarily represent physically separate hardware and/or software components. Certain computing devices provide main memory 220 and storage 250, for example, in a single physical memory device, and in other cases, memory 220 and/or storage 250 are functionally distributed across many physical devices. In the case of virtual machines or hypervisors, all or part of a function may be provided in the form of software or firmware running over a virtualization layer to provide the disclosed logical function. In other examples, a device such as a network interface 260 may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, microcode, programmable logic, or objects that can coordinate to achieve a logical operation.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of logic elements operable to execute instructions, whether loaded from memory, or implemented directly in hardware, including by way of non-limiting example a microprocessor, digital signal processor, field-programmable gate array, graphics processing unit, programmable logic array, application-specific integrated circuit, or virtual machine processor. In certain architectures, a multi-core processor may be provided, in which case processor 210 may be treated as only one core of a multi-core processor, or may be treated as the entire multi-core processor, as appropriate. In some embodiments, one or more co-processor may also be provided for specialized or support functions.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this specification, and that other memory architectures are available.

Operating system 222 may be provided, though it is not necessary in all embodiments. For example, some embedded systems operate on “bare metal” for purposes of speed, efficiency, and resource preservation. However, in contemporary systems, it is common for even minimalist embedded systems to include some kind of operating system. Where it is provided, operating system 222 may include any appropriate operating system, such as Microsoft Windows, Linux, Android, Mac OSX, Apple iOS, Unix, or similar. Some of the foregoing may be more often used on one type of device than another. For example, desktop computers or engineering workstation may be more likely to use one of Microsoft Windows, Linux, Unix, or Mac OSX. Laptop computers, which are usually a portable off-the-shelf device with fewer customization options, may be more likely to run Microsoft Windows or Mac OSX. Mobile devices may be more likely to run Android or iOS. Embedded devices often use an embedded Linus or a dedicated embedded OS such as VxWorks. However, these examples are not intended to be limiting.

Storage 250 may be any species of memory 220, or may be a separate device. Storage 250 may include one or more non-transitory computer-readable mediums, including by way of non-limiting example, a hard drive, solid-state drive, external storage, redundant array of independent disks (RAID), redundant array of independent nodes (RAIN), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of client engine 224. In some examples, storage 250 may be a non-transitory computer-readable storage medium that includes hardware instructions or logic encoded as processor instructions or on an ASIC. Many other configurations are also possible, and are intended to be encompassed within the broad scope of this specification.

Network interface 260 may be provided to communicatively couple client device 200 to a wired or wireless network. A “network,” as used throughout this specification, may include any communicative platform or medium operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Client engine 224, in one example, is operable to carry out computer-implemented methods as described in this specification. Client engine 224 may include one or more tangible non-transitory computer-readable mediums having stored thereon executable instructions operable to instruct a processor to provide a client engine 224. As used throughout this specification, an “engine” includes any combination of one or more logic elements, of similar or dissimilar species, operable for and configured to perform one or more methods provided by the engine. Thus, client engine 224 may comprise one or more logic elements configured to provide methods as disclosed in this specification. In some cases, client engine 224 may include a special integrated circuit designed to carry out a method or a part thereof, and may also include software instructions operable to instruct a processor to perform the method. In some cases, client engine 224 may run as a “daemon” process. A “daemon” may include any program or series of executable instructions, whether implemented in hardware, software, firmware, or any combination thereof that runs as a background process, a terminate-and-stay-resident program, a service, system extension, control panel, bootup procedure, BIOS subroutine, or any similar program that operates without direct user interaction. In certain embodiments, daemon processes may run with elevated privileges in a “driver space” associated with ring 0, 1, or 2 in a protection ring architecture. It should also be noted that client engine 224 may also include other hardware and software, including configuration files, registry entries, and interactive or user-mode software by way of non-limiting example.

In one example, client engine 224 includes executable instructions stored on a non-transitory medium operable to perform a method according to this specification. At an appropriate time, such as upon booting client device 200 or upon a command from operating system 222 or a user 120, processor 210 may retrieve a copy of the instructions from storage 250 and load it into memory 220. Processor 210 may then iteratively execute the instructions of client engine 224 to provide the desired method.

Client engine 224 may enable, for example, client device 110 or user equipment 164 to connect to and access resources on secured network 170, either directly or via network 172. In certain cases, secured enterprise 100 may need to meet service level agreements (SLAs) associated with such access.

Peripheral interface 240 may be configured to interface with any auxiliary device that connects to client device 200 but that is not necessarily a part of the core architecture of client device 200. A peripheral may be operable to provide extended functionality to client device 200, and may or may not be wholly dependent on client device 200. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage by way of non-limiting example.

In one example, peripherals include display adapter 242, audio driver 244, and input/output (I/O) driver 246. Display adapter 242 may be configured to provide a human-readable visual output, such as a command-line interface (CLI) or graphical desktop such as Microsoft Windows, Apple OSX desktop, or a Unix/Linux X Window System-based desktop. Display adapter 242 may provide output in any suitable format, such as a coaxial output, composite video, component video, VGA, or digital outputs such as DVI or HDMI, by way of nonlimiting example. In some examples, display adapter 242 may include a hardware graphics card, which may have its own memory and its own graphics processing unit (GPU). Audio driver 244 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth or Wi-Fi audio, by way of non-limiting example.

FIG. 3 is a block diagram of a server-class device 300 according to one or more examples of the present specification. Server 300 may be any suitable computing device, as described in connection with FIG. 2. In general, the definitions and examples of FIG. 2 may be considered as equally applicable to FIG. 3, unless specifically stated otherwise. Server 300 is described herein separately to illustrate that in certain embodiments, logical operations according to this specification may be divided along a client-server model, wherein client device 200 provides certain localized tasks, while server 300 provides certain other centralized tasks. In contemporary practice, server 300 is more likely than client device 200 to be provided as a “headless” VM running on a computing cluster, or as a standalone appliance, though these configurations are not required.

Server 300 includes a processor 310 connected to a memory 320, having stored therein executable instructions for providing an operating system 322 and at least software portions of a network function engine 324. Other components of server 300 include a storage 350, network interface 360. As described in FIG. 2, each logical block may be provided by one or more similar or dissimilar logic elements.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3, or via any other suitable memory configuration. As discussed in FIG. 2, memory 320 may include one or more logic elements of any suitable type.

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of network function engine 324.

Network interface 360 may be provided to communicatively couple server 300 to a wired or wireless network, and may include one or more logic elements as described in FIG. 2.

Network function engine 324 is an engine as described in FIG. 2 and, in one example, includes one or more logic elements operable to carry out computer-implemented methods as described in this specification. Software portions of network function engine 324 may run as a daemon process.

Network function engine 324 may include one or more non-transitory computer-readable mediums having stored thereon executable instructions operable to instruct a processor to provide network function engine 324. At an appropriate time, such as upon booting server 300 or upon a command from operating system 322 or a user 120 or security administrator 150, processor 310 may retrieve a copy of network function engine 324 (or software portions thereof) from storage 350 and load it into memory 320. Processor 310 may then iteratively execute the instructions of network function engine 324 to provide the desired method.

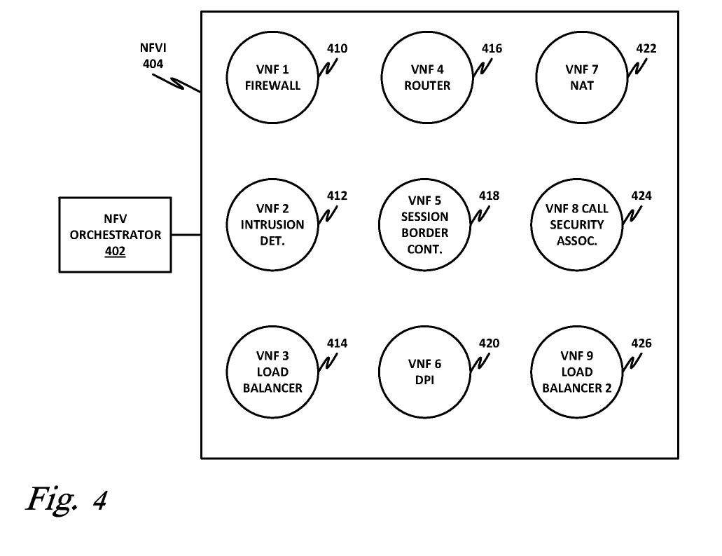

Network function engine 324 may enable a hardware-only service appliance, a virtual service appliance, or any other virtual machine to provide its network function. For example, if the host is a VNF, then network function engine 324 may provide the engine for providing the network function. In the case of a NFVO (e.g., see NFVO 402 of FIG. 4), network function engine 324 may provide an orchestration engine (e.g., 722).

FIG. 4 is a block diagram of a network function virtualization (NFV) architecture according to one or more examples of the present specification. NFV is a subset of network virtualization. Network virtualization may take many forms. For example, in software defined networking (SDN), a data plane is separated from a control plane to realize certain advantages.

NFV is another flavor of network virtualization, often treated as an add-on or improvement to SDN, but sometimes treated as a separate entity. NFV was originally envisioned as a method for providing reduced capital expenditure (Capex) and operating expenses (Opex) for telecommunication services, which relied heavily on fast, single purpose service appliances. One important feature of NFV is replacing proprietary, special-purpose hardware appliances with virtual appliances running on commercial off-the-shelf (COTS) hardware with in a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancer VNFs may be spun up to distribute traffic to more workload servers (which may themselves be virtual machines). In times where more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI). Often, the VNFs are in-line service functions that are separate from workload servers or other nodes (in many cases, workload-type functions were long since virtualized). These VNFs can be chained together into a service chain, which may be defined by a virtual subnetwork, and which may include a serial string of network services that provide behind-the-scenes work, such as security, logging, billing, and similar. In one example, an incoming packet passes through a chain of services in a service chain, with one or more of the services being provided by a VNF, whereas historically each of those functions may have been provided by bespoke hardware in a physical service appliance. Because NFVs can be spun up and spun down to meet demand, the allocation of hardware and other resources can be made more efficient. Processing resources can be allocated to meet the greatest demand, whereas with physical service appliances, any unused capacity on an appliance is simply wasted, and increasing capacity to meet demand required plugging in a physical (expensive) bespoke service appliance.

In the example of FIG. 4, an NFV orchestrator 402 manages a number of the VNFs running on an NFVI 404. NFV requires non-trivial resource management, such as allocating a very large pool of compute resources among appropriate numbers of instances of each VNF, managing connections between VNFs, determining how many instances of each VNF to allocate, and managing memory, storage, and network connections. This may require complex software management, thus the need for NFV orchestrator 402.

Note that VNF orchestrator 402 itself is usually virtualized (rather than a special-purpose hardware appliance). NFV orchestrator 402 may be integrated within an existing SDN system, wherein an operations support system (OSS) manages the SDN. This may interact with cloud resource management systems (e.g., OpenStack) to provide NVF orchestration. There are many commercially-available, off-the-shelf, proprietary, and open source solutions for NFV orchestration and management (sometimes referred to as NFV MANO). In addition to NFV orchestrator 402, NFV MANO may also include functions such as virtualized infrastructure management (VIM) and a VNF manager.

An NFVI 404 may include the hardware, software, and other infrastructure to enable VNFs to run. This may include, for example, a rack or several racks of blade or slot servers (including, e.g., processors, memory, and storage), one or more data centers, other hardware resources distributed across one or more geographic locations, hardware switches, network interfaces. An NFVI 404 may also include the software architecture that enables hypervisors to run and be managed by NFV orchestrator 402. NFVI 402 may include NFVI points of presence (NFVI-PoPs), where VNFs are deployed by the operator.

Running on NFVI 404 are a number of virtual machines, each of which in this example is a VNF providing a virtual service appliance. These include, as nonlimiting and illustrative examples, VNF 1 410, which is a firewall, VNF 2 412, which is an intrusion detection system, VNF 3 414, which is a load balancer, VNF 4 416, which is a router, VNF 5 418, which is a session border controller, VNF 6 420, which is a deep packet inspection (DPI) service, VNF 7 422, which is a network address translation (NAT) module, VNF 8 424, which provides call security association, and VNF 9 426, which is a second load balancer spun up to meet increased demand.

Firewall 410 is a security appliance that monitors and controls the traffic (both incoming and outgoing), based on matching traffic to a list of “firewall rules.” Firewall 410 may be a barrier between a relatively trusted (e.g., internal) network, and a relatively untrusted network (e.g., the internet). Once traffic has passed inspection by firewall 410, it may be forwarded to other parts of the network.

Intrusion detection 412 monitors the network for malicious activity or policy violations. Incidents may be reported to security administrator 150, or collected and analyzed by a security information and event management (SIEM) system. In some cases, intrusion detection 412 may also include antivirus or antimalware scanners.

Load balancers 414 and 426 may farm traffic out to a group of substantially identical workload servers to distribute the work in a fair fashion. In one example, a load balancer provisions a number of traffic “buckets,” and assigns each bucket to a workload server. Incoming traffic is assigned to a bucket based on a factor, such as a hash of the source IP address. Because the hashes are assumed to be fairly evenly distributed, each workload server receives a reasonable amount of traffic.

Router 416 forwards packets between networks or subnetworks. For example, router 416 may include one or more ingress interfaces, and a plurality of egress interfaces, with each egress interface being associated with a resource, subnetwork, virtual private network, or other division. When traffic comes in on an ingress interface, router 416 determines when destination it should go to, and routes the packet to the appropriate egress interface.

Session border controller 418 controls voice over IP (VoIP) signaling, as well as the media streams to set up, conduct, and terminate calls. In this context, “session” refers to a communication event (e.g., a “call”). “Border” refers to a demarcation between two different parts of a network (similar to a firewall).

DPI appliance 420 provides deep packet inspection, including examining not only the header, but also the content of a packet to search for potentially unwanted content (PUC), such as protocol non-compliance, malware, viruses, spam, or intrusions.

NAT module 422 provides network address translation services to remap one IP address space into another (e.g., mapping addresses within a private subnetwork onto the larger internet).

Call security association 424 creates a security association for a call or other session (see session border controller 418 above). Maintaining this security association may be critical, as the call may be dropped if the security association is broken.

The illustration of FIG. 4 shows that a number of VNFs have been provisioned and exist within NFVI 404. This figure does not necessarily illustrate any relationship between the VNFs and the larger network.

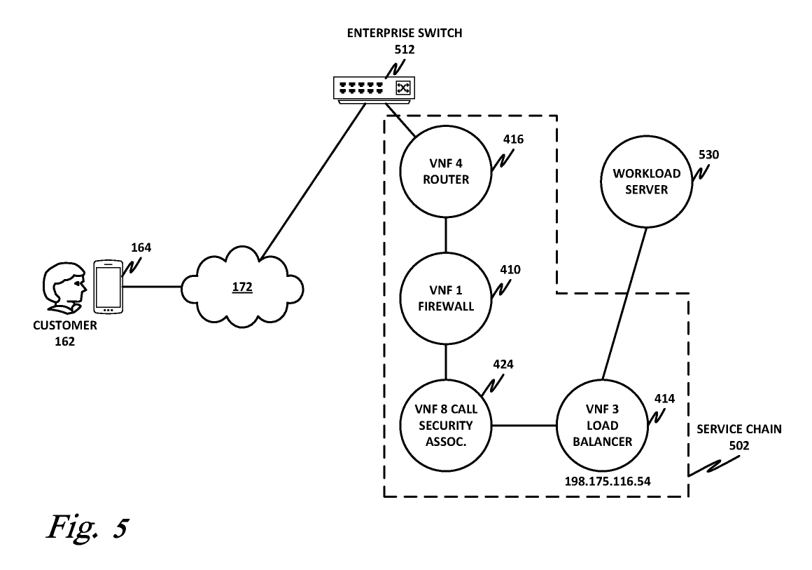

FIG. 5 illustrates an example service chain 502, which may include one or more VNFs. Note that service chain 502 is provided only as an illustrative example, and that certain selected VNFs are shown to illustrate how the functions may be chained together. Service chain 502 is not necessarily a complete service chain. Certain hops in the service chain may be omitted for the purpose of simplicity. Furthermore, not all of the VNFs in service chain 502 are necessary in all cases, and in a general sense, any suitable number of VNFs, in any order, may be chained together to form a service chain according to the needs of a particular application.

In this example, customer 162 operates user equipment 164 to communicate with secured enterprise 100 via network 172. In this example, customer 162 may be trying to access an internet resource available at IP address 198.175.116.54, operated by secured enterprise 100. When customer 162 issues a request to the IP address, network 172 looks up the IP address and forwards a request to enterprise switch 512 operated by secured enterprise 100. In this case, IP address 198.175.116.54 may actually map to a load balancer 414. However, before the packet is provided to load balancer 414, it may need to traverse several network functions.

First, enterprise switch 512 directs the packet to a router 416. Router 416 may look up the IP address and determine which virtual subnetwork the traffic should be directed to, and what service chain should applied. According to the service chain, router 416 then forwards the packet to firewall 410.

Firewall 410 may have certain firewall rules that determine whether the packet should be blocked or forwarded, or otherwise disposed. After firewall 410 has inspected the packet and determined that it should be forwarded, it is sent to call security association appliance 424.

In this case, if the data includes a voice over IP call, call security association appliance 424 may create a security association for the call and attach it to the packet. Call security association appliance 424 then forwards the packet to load balancer 414, which has the IP address 198.175.116.54. Load balancer 414 applies a load-balancing algorithm to direct the packet to one of a plurality of workload servers 530. The selected workload server 530 receives the packet and handles it.

Note that because service chain 502 includes a series of linear transactions, any service appliance within service chain 502 can become a bottleneck if it is unnecessarily delayed. Thus, isn't it is advantageous to ensure that service appliances hosted on VNFs are low latency and can handle traffic in an efficient manner to ensure that the service chain 502 does not become a bottleneck for the overall network architecture.

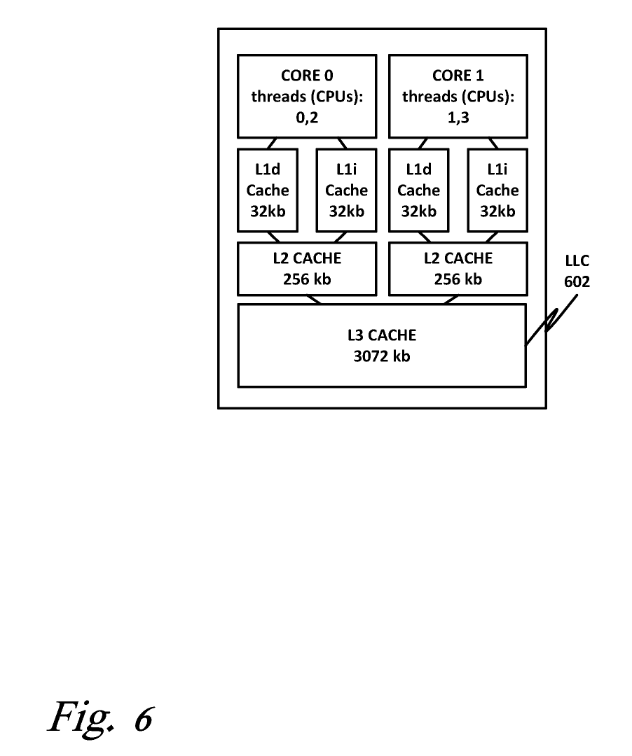

FIG. 6 is a block diagram of a system architecture with multiple levels of cache, according to one or more examples of the present specification.

In this example, the system includes two cores, with core 0 and core 1, each of which may include two CPU threads.

Each of these CPUs may have a level 1 cache, which in this example is 32 Kilobytes. This is the smallest and fastest cache.

The processors may also have a level 2 cache with 256 kB.

Finally, the processors may have a level 3 cache of approximately 3 MB. This level 3 cache, being the farthest from the processor, may be considered the last level cache (LLC). Management of the LLC cash is one important function provided by Intel® RDT. Certain portions of the L3 cache are shared by all cores in the socket.

When a processor tries to access a data location, it first tries to find the data in the L1 cache. If this cache misses, it next tries L2 cache. If this cache misses, it finally tries L3 cache. If the data location is not found in L3 cache, then a cache miss occurs, and the location must be accessed from main memory, which may be orders of magnitude slower than cache.

Each LLC block is N-way set associative. For example, in a modern Intel® Xeon® processor with RTD capability, the LLC has 20 ways.

LLC in typical Intel Xeon E5 v4 part has 20 ways. Note that neither core “owns” a corresponding LLC block. Any LLC block can be used by any core.

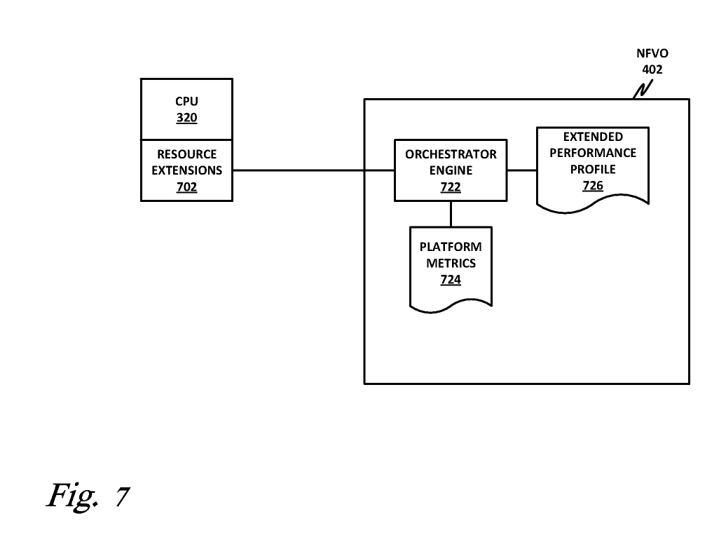

FIG. 7 is a block diagram of metrics collection according to one or more examples of the present specification. In the example of FIG. 7, a CPU 320 includes resource extensions 702. Resource extension 702 may be, for example, Intel® resource director technology (RDT) or equivalent.

CPU 320 is communicatively coupled to an NFVO 402. NFVO 402 includes in this example an orchestrator engine 722. Orchestrator engine 722 is configured to communicate with resource extensions 702 and store for VNFs both platform metrics 724 and an extended performance profile 726, as described in greater detail in paragraphs [0018]-[0023] above.

Intel® RDT provides a number of extensions for optimizing resource usage in contexts like NFV.

Cache Monitoring Tech (CMT)
a. Per-thread L3 Occupancy Monitoring
b. 4 Resource Monitoring IDs per logical thread
c. Identify misbehaving applications and reschedule according to priority
d. Cache Occupancy reported on a per Resource Monitoring ID (RMID) basis for advanced telemetry

Memory BW Monitoring (MBM)
a. Per-thread Memory Bandwidth Monitoring
b. Leverages RMID infrastructure
c. Monitors Memory Bandwidth consumption on per thread/core/app basis
d. Shares common RMID architecture
e. Provides insight into second order of shared resource contention

Cache Allocation Tech (CAT)

LLC is shared to make best use of the resources in the platform. However certain types of applications can cause noise and slow down others. Streaming-type applications can cause excessive LLC evictions. CAT provides. CAT provides:
a. Per-thread L3 Occupancy Control
b. Code and Data Prioritization (CDP)
c. Intel® Xeon® processor E5 v4 introduce 16 Classes of Service
d. A Last Level Cache partitioning mechanism enables separation and prioritization of apps or VMs
e. Misbehaving threads can be isolated to increase determinism

RDT supplements existing telemetry solutions, such as the following, by way of nonlimiting example:
a. Counters
b. Perfmon (performance counter monitor)
c. Intel® Node Manager
d. Snap (open source project)
e. Utilities in Kernel & VMM

RDT interfaces are based on Model-Specific Registers (MSRs). These can be used by operating systems, hypervisors, or privileged advanced software.

In the context of NFV, RDT provides features such as the following, by way of nonlimiting example.
a. Prioritizing Important Apps: Without Cache Allocation Technology, LLC contention causes 38% performance degradation. Performance is restored utilizing CAT
b. Average Latency is reduced from 36 μsec to 7 μsec after isolation of noisy neighbors
c. Ethernet controllers and NICs talk directly with CPU cache
d. DDIO makes processor cache the primary source and destination of I/O data, rather than main memory
e. DDIO reduces latency, power consumption, and memory bandwidth
f. Lower latency—I/O date does not need to go via main memory
g. Lower power consumption—reduced memory access
h. More scalable I/O bandwidth—reduced memory bottlenecks

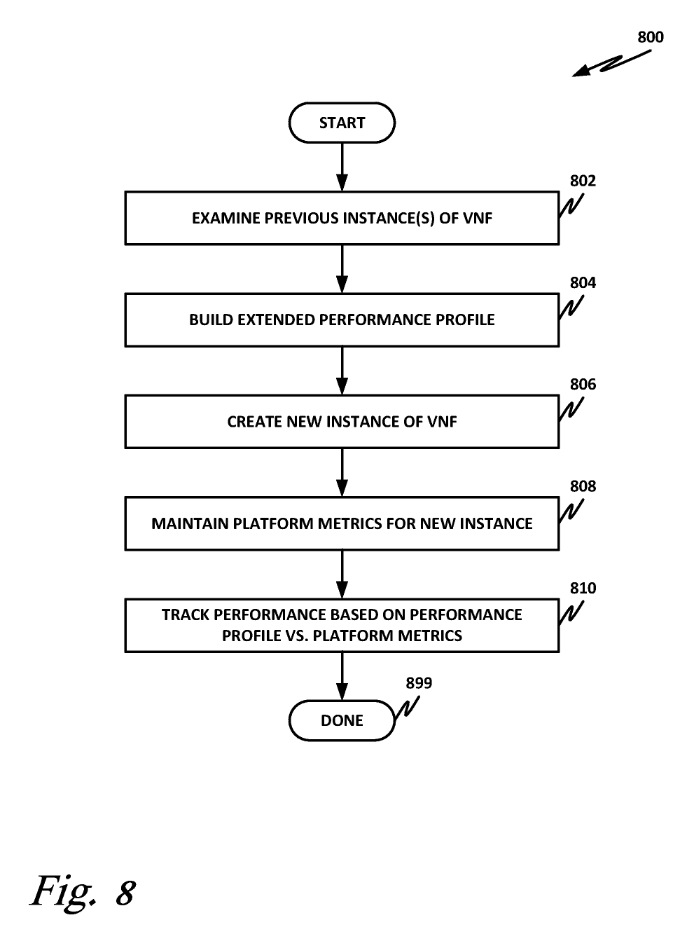

FIG. 8 is a flowchart of a method of collecting metrics according to one or more examples of the present specification.

In block 802, orchestrator 402 examines one or more previous instances of the VNF.

In block 804, based on the one or more previous instances of the VNF, orchestrator 402 builds an extended performance profile. The extended performance profile is a metric of how the VNF has performed historically, thus forming a baseline against which currently running VNF instances can be compared.

In block 806, orchestrator 402 creates a new instance of the VNF.

In block 808, orchestrator 402 maintains platform metrics for the new instance as described above.

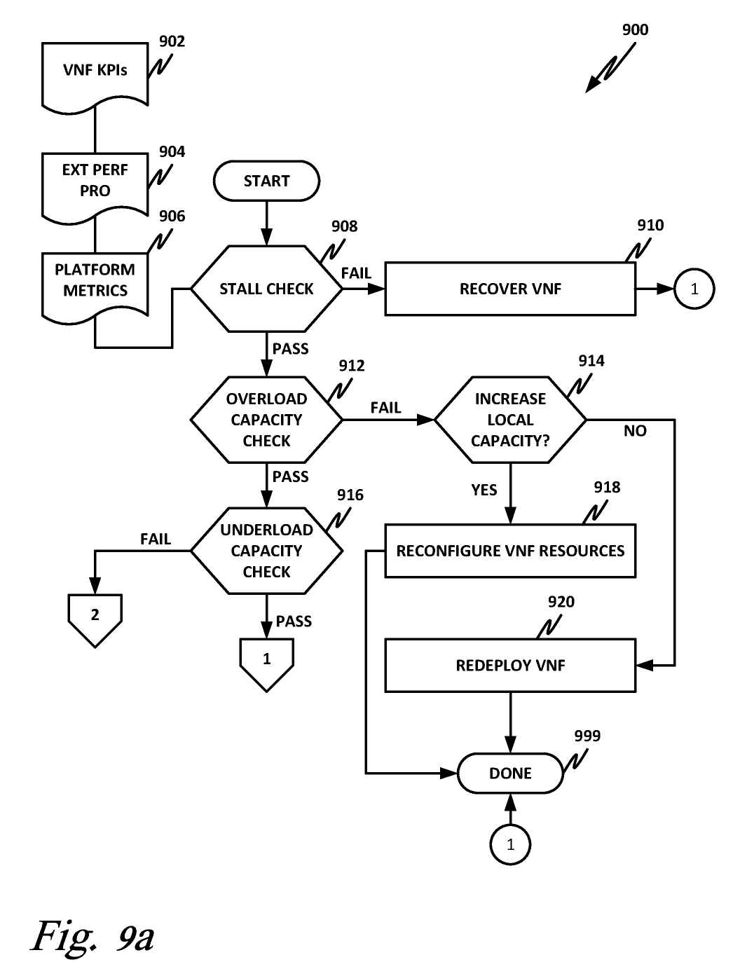

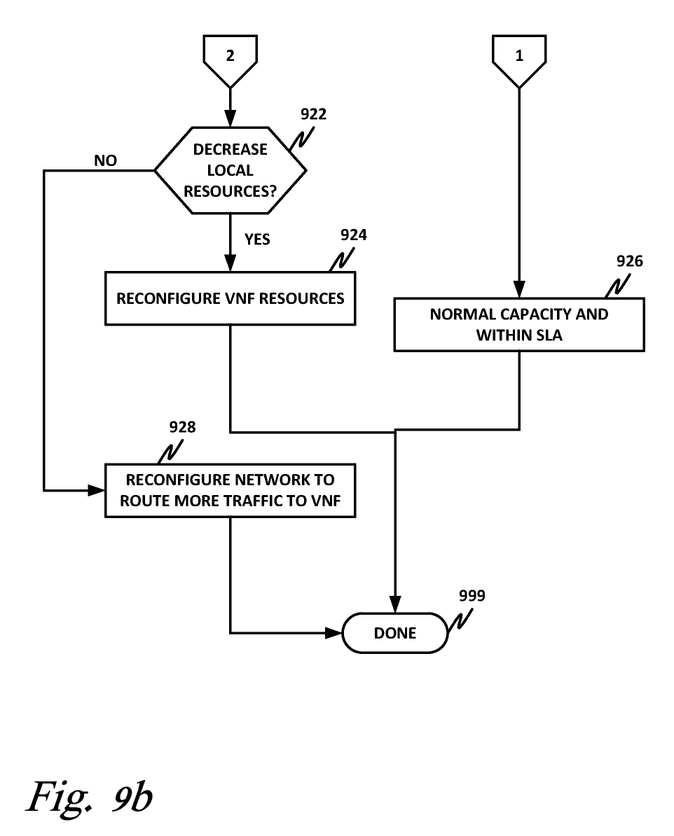

In block 810, orchestrator 402 tracks performance of the new VNF instance based on a comparison of the extended performance profile against the platform metrics for the new instance. Examples of certain decisions that can be made based on this comparison are disclosed in FIGS. 9a and 9b.

In block 899, the method is done.

FIGS. 9a and 9b are a flow chart of a method 900 that may be performed, for example, by orchestrator 402 according to one or more examples of the present specification. Note, however, that the method is not limited to orchestrator 402, and may be performed by any suitable computing system. Also note that branches and operations are disclosed in a particular order only to illustrate one potential way of ordering the operations. It should be appreciated that the order of operations disclosed herein may be changed. In particular, the order of stall testing, overload testing, and underload testing is not intended to be fixed.

In this case, in block 902, key performance indicators for the VNF are provided. In block 904, the extended performance profile is provided. In block 906, the platform metrics are provided.

As appropriate, one or more of these may be considered as an input to any of the decision blocks of the flowchart. Thus, although these are shown feeding directly into block 908, they may be similarly deemed to flow into any of the other decision blocks. Also note that depending on the context, not all of these metrics need be used, and other metrics may be used as appropriate.

In block 908, orchestrator 402 uses a comparison of the platform metrics to the extended performance profile to determine whether the virtual machine is stalled. Determining whether the virtual machine is stalled is described in more detail in paragraph [0027] above.

If the stall check fails, then the VNF is stalled, and in block 910, orchestrator 402 recovers the VNF. This can include, for example, restarting the VNF to a safe or known operational state.

After recovering the VNF, then following on-page connector 1, in block 999 the method is done.

Returning to block 908, if the stall check passes, then in decision block 912, orchestrator 402 performs an overload capacity check. This determines whether the capacity of the VNF is overloaded, meaning that for example that the VNF is handling more traffic than is optimal capacity. An overload capacity check is described in paragraph [0028] above. If that is a case, then the VNF may be functioning inefficiently, and may become a bottleneck for the network.

If the overload capacity check fails, then the VNF is overloaded, and in decision block 914, orchestrator 402 determines whether it is possible to increase the local capacity, such as by allocating additional processors, memory, or network bandwidth to the VNF on the machine that it is currently hosted on. If this is possible, then in block 918, orchestrator 402 reconfigures VNF resources so that the VNF has sufficient resources to obviate the overload condition.

If it is not possible to increase local capacity, then in block 920, the VNF may need to be redeployed onto a platform with greater compute capacity, or additional instances of the VNF may need to be deployed on additional hardware.

Flowing from either block 918 or 920, in block 999, the method is done.

Returning to block 912, if the VNF passes the overload capacity check, then in block 916, orchestrator 402 checks whether the VNF capacity is under loaded. An underload check is described in paragraph [0029] above. This may occur, for example, where the VNF is using substantially less than all of its allocated resources for a sufficiently long time that it appears that the compute resources allocated to the VNF are going to waste. A pass of this check flows to off-page connector 1, while a fail flows to off-page connector 2.

Turning to FIG. 9B, the flow may proceed from off-page connector 1 or off-page connector 2.

Starting with off-page connector 2, in decision block 922, orchestrator 402 determines whether it is possible to decrease local resources. For example can some resources be stripped from the VNF and allocated to other services provided by the hardware architecture.

If it is possible to reconfigure the VNF resources locally, then in block 924, resources are reconfigured to allocate some of the resources for the VNF to other workflows that are in greater need of the capacity.

If it is not possible to decrease local resources on the VNF, then in block 928, orchestrator 402 may reconfigure the network routing so that more traffic is routed to this instance of the VNF. This allows it to operate more efficiently and closer to its optimal capacity.

Flowing from either block 924 or block 928, in block 999 the method is done.

Returning to off-page connector 1, in this case, the VNF has passed all of the tests in this flow, meaning that VNF is operating with normal capacity and within the service level agreement. In this case, there is no need to provide any changes or adjustment.

Thus, in block 999, the method is done.

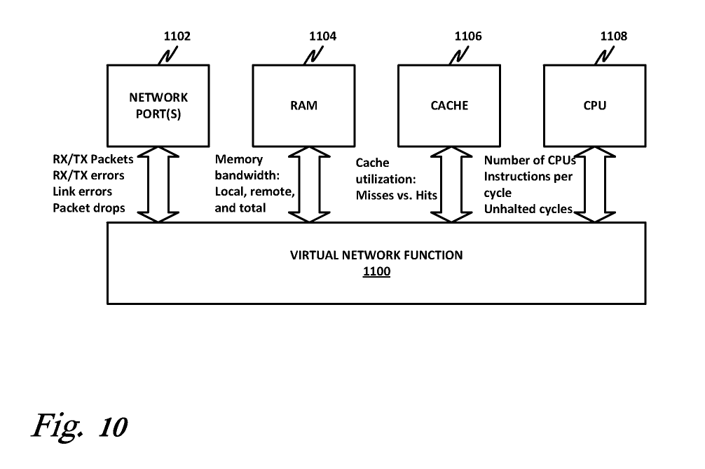

FIG. 10 is a block diagram of metric monitoring that may be performed according to one or more examples of the present specification.

In this example, a VNF 1100 is associated with the metrics of network ports 1102, RAM 1104, cache 1106, and CPU 1108.

Factors for monitoring network port allocation include the number of RX/TX packet, the number of RX/TX error, the number of link errors, and the number of dropped packets.

Factors for monitoring RAM usage may include memory bandwidth, including the local, remote, and total bandwidth.

Factors for monitoring cache 1106 may include cache utilization, and cache hits versus cache misses.

Factors for monitoring CPU usage may include the number of CPUs or cores allocated, instructions per cycle, and the number or percentage of unhalted cycles (e.g., current CPU usage).

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices 110 or server devices 300 may be provided, in whole or in part, in an SoC. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Note also that in certain embodiment, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor, such as processor 210, can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage such as storage 250 may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, such as memory 220 and storage 250, should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor such as processor 210 to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### Example Implementations

There is disclosed in one example, a computing apparatus, comprising: a processor having a resource direction capability; and one or more logic elements comprising a network function virtualization orchestrator (NFVO) engine to: store for a virtual machine (VM) an extended performance profile, comprising a metric from the resource direction capability.

There is also disclosed an example, wherein the metric comprises a last-level cache (LLC) size.

There is also disclosed an example, wherein the metric comprises memory bandwidth.

There is also disclosed an example, wherein the NFVO engine is further to store platform metrics.

There is also disclosed an example, wherein the NFVO is to make operational decisions based at least in part on a comparison of the platform metrics to the extended performance profile.

There is also disclosed an example, wherein making operational decisions comprises determining that the VM is stalled, and recovering the VM.

There is also disclosed an example, wherein making operational decisions comprises determining that the VM is over capacity and increasing local capacity.

There is also disclosed an example, wherein making operational decisions comprises determining that the VM is over capacity and redeploying the VM.

There is also disclosed an example, wherein making operational decisions comprises determining that the VM is under capacity and decreasing local resources.

There is also disclosed an example, wherein making operational decisions comprises determining that the VM is under capacity and reconfiguring a network to route more traffic to the VM.

There is also disclosed an example, wherein the virtual machine is a virtual network function (VNF).

There is also disclosed an example of one or more tangible, non-transitory computer-readable mediums having stored thereon executable instructions for providing a (NFVO) engine to: store for a virtual machine (VM) an extended performance profile, comprising a metric from a resource direction capability of a processor hosting the VM.

There is also disclosed an example, wherein the metric comprises a last-level cache (LLC) size.

There is also disclosed an example, wherein the metric comprises memory bandwidth.

There is also disclosed an example, wherein the NFVO engine is further to store platform metrics.

There is also disclosed an example, wherein the NFVO is to make operational decisions based at least in part on a comparison of the platform metrics to the extended performance profile.

There is also disclosed an example, wherein making operational decisions comprises determining that the VM is stalled, and recovering the VM.

There is also disclosed an example, wherein making operational decisions comprises determining that the VM is over capacity and increasing local capacity.

There is also disclosed an example, wherein making operational decisions comprises determining that the VM is over capacity and redeploying the VM.

There is also disclosed an example, wherein making operational decisions comprises determining that the VM is under capacity and decreasing local resources.

There is also disclosed an example, wherein making operational decisions comprises determining that the VM is under capacity and reconfiguring a network to route more traffic to the VM.

There is also disclosed an example, wherein the virtual machine is a virtual network function (VNF).

There is also disclosed an example of a computer-implemented method of providing a network function virtualization orchestrator (NFVO), comprising: storing for a virtual machine (VM) an extended performance profile, comprising a metric from a resource direction capability of a processor hosting the VM.

There is also disclosed an example, wherein the metric comprises a last-level cache (LLC) size.

There is also disclosed an example, wherein the metric comprises memory bandwidth.

There is also disclosed an example, further comprising storing platform metrics.

There is also disclosed an example, further comprising making operational decisions based at least in part on a comparison of the platform metrics to the extended performance profile.

There is also disclosed an example, wherein making operational decisions comprises determining that the VM is stalled, and recovering the VM.

There is also disclosed an example, wherein making operational decisions comprises determining that the VM is over capacity and increasing local capacity.

There is also disclosed an example, wherein making operational decisions comprises determining that the VM is over capacity and redeploying the VM.

There is also disclosed an example, wherein making operational decisions comprises determining that the VM is under capacity and decreasing local resources.

There is also disclosed an example, wherein making operational decisions comprises determining that the VM is under capacity and reconfiguring a network to route more traffic to the VM.

There is also disclosed an example, wherein the virtual machine is a virtual network function (VNF).

There is also disclosed an example of an apparatus comprising means for performing the method.

There is also disclosed an example, wherein the means for performing the method comprise a processor and a memory.

There is also disclosed an example, wherein the memory comprises machine-readable instructions, that when executed cause the apparatus to perform the method.

There is also disclosed an example, wherein the apparatus is a computing system.

There is also disclosed an example of at least one computer readable medium comprising instructions that, when executed, implement the method or realize the apparatus.

What is claimed is:

1. A computing apparatus, comprising:
a processor having a resource direction capability; and
one or more logic elements comprising a network function virtualization orchestrator (NFVO) engine to:
store for a virtual machine (VM) an extended performance profile, comprising a metric from the resource direction capability.

2. The computing apparatus of claim 1, wherein the metric comprises a last-level cache (LLC) size.

3. The computing apparatus of claim 1, wherein the metric comprises memory bandwidth.

4. The computing apparatus of claim 1, wherein the NFVO engine is further to store platform metrics.

5. The computing apparatus of claim 4, wherein the NFVO is to make operational decisions based at least in part on a comparison of the platform metrics to the extended performance profile.

6. The computing apparatus of claim 5, wherein making operational decisions comprises determining that the VM is stalled, and recovering the VM.

7. The computing apparatus of claim 5, wherein making operational decisions comprises determining that the VM is over capacity and increasing local capacity.

8. The computing apparatus of claim 5, wherein making operational decisions comprises determining that the VM is over capacity and redeploying the VM.

9. The computing apparatus of claim 5, wherein making operational decisions comprises determining that the VM is under capacity and decreasing local resources.

10. The computing apparatus of claim 5, wherein making operational decisions comprises determining that the VM is under capacity and reconfiguring a network to route more traffic to the VM.

11. The computing apparatus of claim 1, wherein the virtual machine is a virtual network function (VNF).

12. One or more tangible, non-transitory computer-readable mediums having stored thereon executable instructions for providing a (NFVO) engine to:
store for a virtual machine (VM) an extended performance profile, comprising a metric from a resource direction capability of a processor hosting the VM.

13. The one or more tangible, non-transitory computer-readable mediums of claim 12, wherein the metric comprises a last-level cache (LLC) size.

14. The one or more tangible, non-transitory computer-readable mediums of claim 12, wherein the metric comprises memory bandwidth.

15. The one or more tangible, non-transitory computer-readable mediums of claim 12, wherein the NFVO engine is further to store platform metrics.

16. The one or more tangible, non-transitory computer-readable mediums of claim 15, wherein the NFVO is to make operational decisions based at least in part on a comparison of the platform metrics to the extended performance profile.

17. The one or more tangible, non-transitory computer-readable mediums of claim 16, wherein making operational decisions comprises determining that the VM is stalled, and recovering the VM.

18. The one or more tangible, non-transitory computer-readable mediums of claim 16, wherein making operational decisions comprises determining that the VM is over capacity and increasing local capacity.

19. The one or more tangible, non-transitory computer-readable mediums of claim 16, wherein making operational decisions comprises determining that the VM is over capacity and redeploying the VM.

20. The one or more tangible, non-transitory computer-readable mediums of claim 16, wherein making operational decisions comprises determining that the VM is under capacity and decreasing local resources.

21. The one or more tangible, non-transitory computer-readable mediums of claim 16, wherein making operational decisions comprises determining that the VM is under capacity and reconfiguring a network to route more traffic to the VM.

22. The one or more tangible, non-transitory computer-readable mediums of claim 12, wherein the virtual machine is a virtual network function (VNF).

23. A computer-implemented method of providing a network function virtualization orchestrator (NFVO), comprising:
storing for a virtual machine (VM) an extended performance profile, comprising a metric from a resource direction capability of a processor hosting the VM.

24. The method of claim 23, wherein the metric comprises a last-level cache (LLC) size.

25. The method of claim 23, wherein the metric comprises memory bandwidth.
